(19) United States
(12) Patent Application Publication
(10) Pub. No.: US 2009/0305189 A1
(43) Pub. Date: Dec. 10, 2009

(54) Dental implantology device

(75) Inventors: Gérard Scortecci, Nice (FR); Carl Erwin Misch, Orchard Leke, MI (US)

Correspondence Address: YOUNG & THOMPSON, 209 Madison Street, Suite 500, ALEXANDRIA, VA, 22314, US

(73) Assignee: GERRARD SCORTECCI, NICE (FR)

(21) Appl. No.: 11/919,514

(22) PCT Filed: Apr. 21, 2006
(86) PCT No.: PCT/EP2006/061761

§ 371 Date: Oct. 29, 2007

(30) Foreign Application Priority Data
Apr. 29, 2005 (FR) 0551123

(51) Int. Cl. A61C 3/02; A61C 8/00

(52) U.S. Cl. 433/165; 433/174

(57) ABSTRACT

The invention relates to a dental implantology device combining a specific drill (21) which is adapted to jawbone density variations and an implant (1) which is formed in a corresponding manner to the drill (21) and which is also adapted to bone density variations. According to the invention, the implant (1) and the drill (2) comprise a plurality of zones over the heights thereof, which are suitably produced such that the drill (21) alone is used to form the seat for the implant (1). The invention is suitable for high-precision dental implantology.

This invention relates to a dental implantology device. More accurately, this device includes both a drilling tool and an implant homologous to the tool that allows a prosthetic device to be anchored.

The invention suggests more exactly an implant, advantageously of pure titanium, profiled to adapt to the anatomical specifics of the osseous maxillary and mandibular structures.

A prosthetic device is defined as any assembly that can be attached to the implant in order to form a dental prosthesis for one or more teeth.

An implant homologous to the drilling tool is defined as any structure that can be inserted into the bone, advantageously immediately after passage of said tool without the need to widen or to modify the drilling by tapping.

Dental implantology is a field that is growing dramatically, and many implants and implantation tools have already been devised.

Conventionally, the practitioner, to position the implants following an axial vertical direction, makes a hole that is used as the seat of the implant. This hole is made by successive drillings with drilling tools of different and increasing diameters. Generally, at least two or three drilling tools are used. The hole is finished by a tap. Using six tools in succession to position the implant is not unknown.

The use of these multiple tools involves the disadvantage of prolonging the implantation procedure. Moreover, problems of alignment of the successive tool axes arise. Moreover, there are the risks of ovalization, heating or jamming.

Moreover, standard tools are not particularly well adapted to the implant to be anchored and do not comprise any safety stop that allows the drill to be stopped in its progression to prevent its untimely penetration into a nerve, into the sinus cavities or nasal passages.

Moreover, the drills and implants currently in use do not adequately take into account the specifics of the osseous structure, especially with respect to variations in density.

There is thus a need to improve anchoring of dental implants by an optimum combination of a tool and an implant. The implant is thus perfectly calibrated depending on the drilling tool, and these two elements advance in perfect accord.

One advantage of the invention is that the drilling tool is perfectly designed as a function of the variations of the osseous density conventionally encountered during passage into the jawbone, but likewise anatomical risks (nerves, sinus cavity, nasal passages). For this purpose, the drilling tool is equipped with an active safety stop. Actually, the mandibular or maxillary bone has a transition zone with a density that delineates an upper, denser zone and a lower, spongier zone. The staggered configuration of the drilling tool suggested here as well as the different zones following the height of the implant of the invention make it possible to adapt to these variations of density. The tool suggested here, moreover, advantageously ensures a single pass and without any other material, the formation of a hole, allowing primary blocking of the implant that is absolutely critical for its future integration into the bone.

It should be noted, moreover, that the implant according to the invention—according to its preferred embodiment—has a cylindrical part surrounded by two truncated conical parts that, in combination with its cylindrical drilling effected by the stages of the drilling tool, allow the wall of the endo-osseous hole to be placed under compression such that the implant compacts the peripheral osseous zone. This yields a wedging effect on the implant during gentle passage of each stratum formed by the tool. In the case of a necessity to withdraw, it is sufficient to activate in reverse the implant driving system to disengage it from the receiving bed.

According to one advantageous possibility of the invention, the implant is self-tapping starting from its base to its crest to allow release of the hydraulic pressure and to effect tapping while it is being put into place. The undercut of the cutting parts of the tap has a vertical orientation following the axis of the implant and is not helicoidal. The applicants have stated that this arrangement would allow optimum evacuation of the hydraulic pressure and bone debris during self-tapping.

According to other preferred possibilities of the invention, the implant comprises on at least one part of its periphery, but advantageously its entirety, macro-threading on which micro-threading is itself done, then a nano texture. This combination makes it possible to considerably increase the contact surface between the implant and the osseous wall. The macro-threading and the micro-threading proceed at the same time in the drill hole in the course of implantation in contrast to other patterns currently found on the market.

According to another possibility, the implant comprises retaining cups at the level of the thread sides to ensure stem cells for the bone reconstruction. More especially, these cups are a back-up zone of a large number of stem cells and prevent their release while the implant is being put into place.

Other objectives and advantages will become apparent in the course of the following description of one preferred embodiment of the invention that, however, is not limiting.

This invention relates to a dental implantology device comprising a tool for drilling the jawbone and an implant that is able to anchor a prosthetic device. According to the invention, this device is such that:

a—The drilling tool has five stages with the following in succession:
a centering stage at the level of the distal end,
an apical pilot drilling stage
a stage of central widening of the diameter that is larger than that of the pilot drilling state,
a terminal drilling stage with a diameter that is larger than that of the preceding stages,
a crestal stop stage at the level of the proximal end of the drilling tool;

b—The implant is shaped homologously to the drilling tool and comprises five zones over its height, with the following in succession:
an apical rounded zone with a height that is essentially less than or equal to that of the centering stage,
a truncated conical base zone with a height that is essentially equivalent to that of the pilot drilling stage of the drilling tool,
a central cylindrical anchoring zone with a height that is essentially equivalent to that of the central widening stage of the drilling tool,
a terminal, truncated conical anchoring zone with a height that is essentially equivalent to that of the terminal drilling stage of the drilling tool,
a stop zone with a height that is essentially equivalent to that of the crestal stop stage of the drilling tool.

According to preferred variants, this device is such that:
the terminal anchoring zone of the implant has a height of between 20% and 35% of the total height of the implant,

the terminal anchoring zone of the implant has a height of between 1.7 and 3.5 mm,
the stop stage of the drilling tool is a recess whose lateral surface has a section profile,
the implant comprises four lengthwise tapping grooves starting from the apical zone to the terminal anchoring zone,
the central anchoring zone and the base zone of the implant comprise primary threading, on the surface of which secondary threading of a smaller dimension is formed,
the primary threading has a pitch of 0.9 mm and the secondary threading has a pitch between 0.25 mm and 0.4 mm,
the terminal anchoring zone of the implant comprises threading whose pitch is between 0.25 mm and 0.4 mm,
the threaded peripheral surface of the implant has an additional nanometric pattern,
the sides of the primary threading comprise receiving cups of the stem cells,
the primary threading is symmetrically trapezoidal,
the primary threading is asymmetrically trapezoidal,
the primary threading has a rectangular profile.

The attached drawings are given by way of example and do not limit the invention. They represent only one embodiment of the invention and will allow it to be easily understood.

FIG. 1 shows a general view of the implant according to the invention in one embodiment, and FIG. 2 shows in parallel a conformation of the drilling tool in accordance with the structure of the implant.

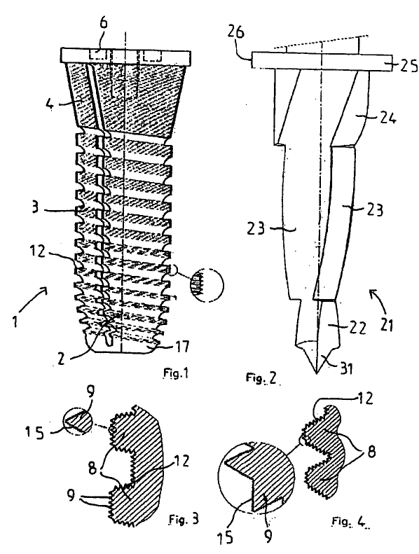

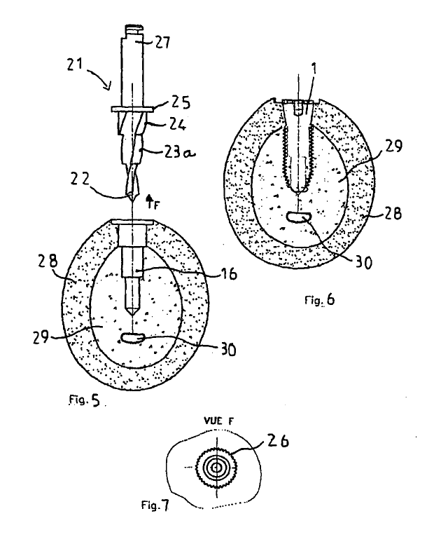

FIGS. 3 and 4 show variant embodiments of the threading made on the outside surface of the implant.

FIG. 5 shows an example of the hole made in the jawbone to receive an implant, the placement of which is shown in FIG. 6.

FIG. 7 is a partial view along line F of FIG. 5.

FIG. 8 shows one possibility for the production of grooves that form the tap for the self-tapping function of the implant with 4 grooves.

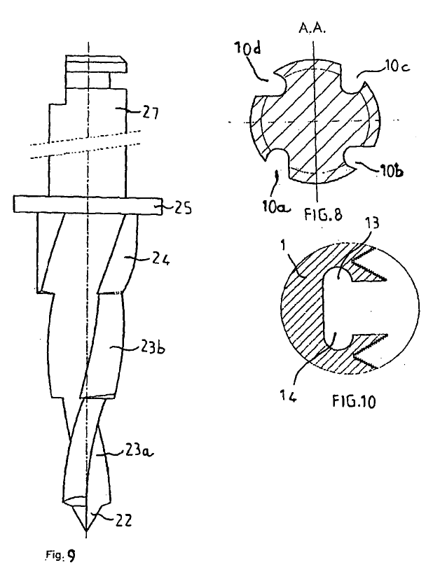

FIG. 9 shows a general view of the drilling tool in one embodiment, and FIG. 10 shows one variant of the invention in which the implant has a system of cups at the level of the peripheral threading.

As indicated above, the invention relates to a specific combination of an implant and a drilling tool. One example of the combination is shown in FIGS. 1 and 2.

In these figures, both the implant 1 and the drilling tool 21 are of a stratified nature.

With respect to the implant 1, more precisely, it comprises, starting from its lower end to its upper end, in succession, a lower surface 7 adjoining an apical zone 17 that is slightly rounded so as to soften the distal end of the implant 1 and a base zone 2 with a truncated conical profile that narrows toward the lower surface 7.

Above the base zone 2, a central anchoring zone shown in cylindrical shape is implemented in the continuation of the largest diameter of the truncated conical part of the base 2.

Beyond the central anchoring zone 3, a terminal anchoring zone 4 is formed and illustrated in a truncated zone shape proceeding as it flares toward the proximal end of the implant 1, i.e., its crest.

Covering the terminal anchoring zone 4, a crestal stop zone 5 is formed. The diameter of the stop zone 5 is slightly larger than that of the largest diameter of the terminal anchoring zone 4 so as to maintain a peripheral stop surface 11.

In a corresponding manner, the drilling tool 21 of the invention comprises, starting from its lower part to its upper end, with reference to FIGS. 2 and 9, a centering stage that is able to fix in position the drilling tool in the jawbone during the process of attack of the drill, an apical pilot drilling stage 22 that implements a first drilling stage with a small section, a central widening stage 23 that implements successive drilling of a larger diameter, a terminal drilling stage 24 that ensures terminal working of larger diameter and a stop stage 25 that offers an active safety characteristic for the drilling tool 21 in that it automatically stops the descent of the tool into the hole 16 as it is being formed.

The dimensions of the various component parts of the implant 1 and of the drilling tool 21 are implemented in correspondence. In particular, the pilot drilling stage 22 of the drilling tool 21 has a height that is essentially equivalent to the base zone 2 of the implant 1 and a diameter that is slightly less so as to allow placement by embedding of the base zone 2.

Likewise, the central anchoring zone 3 of the implant 1 has a height that is essentially equivalent to that of the central widening stage 23 of the drilling tool 21. Likewise, the diameter of the implant 1 at this level is slightly larger than that of the central widening zone 23.

Correspondingly, the terminal drilling stage 24 has a height that is essentially equivalent to the terminal anchoring zone 4 of the implant 1. Moreover, the diameter of the drilling tool 21 at this level is essentially equivalent to the smallest diameter of the truncated conical portion of the terminal anchoring zone 4.

More exactly, it is advantageous that the anchoring zone 4 and the stage 24 of the drilling tool 21 have a height that is essentially equivalent to the height of the part of the dense bone 28 of the jawbone. This case is shown especially in FIGS. 5 and 6. Thus, the drilling tool 21 and the implant 1 according to the invention benefit from a possibility of maximum anchoring at this level with a widened section and without reaching the spongier zone 29 of the bone.

The height of the zone 4 and of the stage 24 is configured such that it is equivalent to the thickness of the dense bone 28 of the patient's jaw.

Generally, in view of the morphologies conventionally found in adult patients, the height of the zone 4 and of the stage 24 will advantageously be selected to be between 2.7 and 3.5 mm. These stages of the implant 1 and of the drilling tool 21, moreover, advantageously represent between 20 and 35% of the total height of the implant 1.

Two advantageous examples of selection of the dimension with reference to implant 1 are given below.

### EXAMPLE 1

Height of the apical zone 17: 0.2 mm

Height of the base zone 2: 2 mm

Height of the central anchoring zone 3: 4 mm

Height of the terminal anchoring zone 4: 3.3 mm

Height of the stop zone 5: 0.5 mm

Thus an implant 1 with a total height of 10 mm is formed.

### EXAMPLE 2

Height of the apical zone 17: 0.2 mm

Height of the base zone 2: 2 mm

Height of the central anchoring zone 3: 7 mm

Height of the terminal anchoring zone 4: 3.3 mm

Height of the stop zone 5: 0.5 mm

Thus, an implant 1 with an overall height of 13 mm is formed.

Advantageously, the implant 1 according to the invention, moreover, has a plurality of longitudinal grooves 10a, 10b, 10c, 10d formed along its longitudinal axis and over the entirety of its height except at the level of a portion of the stop zone 5 so as to impart a self-tapping nature to the implant 1. This self-tapping capacity in combination with the conformation of the drilling tool 21 of the invention makes it unnecessary to use any additional tools for placing the implant 1.

Preferably, and with reference to FIG. 8, four grooves 10a, 10b, 10c, 10d that are spaced over 90% of the periphery of the implant 1 are made.

These grooves 10a, 10b, 10c, 10d that are distributed in this way and over the entire height of the implant 1 allow uniform hydraulic decompression completely around the implant 1.

At its upper end, the implant 1 comprises connection means 6 that are able to work with the connected elements and especially a prosthetic device.

Preferably, the connection means 6 comprise a threaded central hole and a peripheral groove with one interior polygonal side and one external circular side.

More precisely, the zone intended to receive the artificial tooth is composed of a one-piece prosthetic projection that is provided with an external hexagon protected by a Morse cone on which there is premounted at the factory a driving ring that allows the implant 1 to be placed. This segment that is located at the level of the crest in immediate proximity to the mucous membrane comprises a smooth, mirror-polished portion that thus advantageously serves as the stop zone 5.

Still advantageously and not shown, at the level of the apical zone 17 that has been rounded without trauma, by the lower surface 7 of the implant 1, a threaded internal hole is made on a portion of the height of the implant 1 that is able to work with a threaded connected pin that allows holding without any contact of the operator with the implant 1.

It is easily understood that, by this possibility, the implant 1 can be manipulated without contact by its upper surface or by its lower surface 7.

In the drawings, one embodiment of the implant 1 according to the invention is shown with a surface that is external to the specific structure that is described in greater detail below. This structure can be implemented in conjunction with the combination of the aforementioned implant 1/drilling tool 21 or individually, with conventional tools.

Thus, in FIG. 1, it is noted that the base zone 2 and the central anchoring zone 3 have a primary threading 8 with a pitch of, for example, 0.9 mm.

According to a first possibility, the profile of the threads of the primary threading 8 is asymmetrically trapezoidal (with one side of the thread more sloped than the other) as shown in FIG. 1. According to another possibility, the primary threading 8 has a symmetrically trapezoidal profile as is shown in FIG. 4. Finally, another variant is shown in FIG. 3 with a rectangular profile.

To greatly increase the contact surface between the bone and the wall of the implant 1, according to the invention, advantageously additional threading, hereinafter called the secondary threading 9, is formed on the external surface itself of the threads of the primary threading 8. A more precise representation of this secondary threading 9 is shown in FIGS. 3 and 4.

By way of example, the secondary threading 9 has a pitch of between 0.25 and 0.40 mm. Although the dimension is less than the primary threading 8, the secondary threading 9 follows the advance of the implant 1 during its insertion into the hole 16 and is placed gradually in working with the osseous wall without inducing its stripping.

It can be easily understood that the threadings 8 and 9 work so as to produce particularly effective anchoring in an osseous zone where mechanical constraints should be distributed optimally since it is a matter of a marked, less dense zone 29 in FIGS. 5 and 6.

Again, preferably all or part of the peripheral surface of the implant 1 comprises a nano-textured pattern in an effort to again increase the contact surface. The nanometric pattern that is formed in this way can be implemented via a chemical attack on the material of the implant 1 (the latter is advantageously made of pure titanium).

At the level of the anchoring zone 4, preferably threading with a pitch that is equivalent to the secondary threading 9 with a nanometric pattern 15 is formed. This configuration ensures gentle frictional anchoring in the cortical bone so as to avoid cracks or even fractures of osseous edges. As indicated above, this portion is itself self-tapping.

According to another advantageous possibility combined with the preceding characteristics or implemented individually, at the level of the primary threading 8, certain threads are remachined so as to produce an additional thread base that forms the upper cups 13 and lower 14 cups respectively. In the example shown in FIG. 10, it is apparent that the housing formed in this way allows a reservoir to be formed to receive the stem cells of the osseous reconstruction.

With respect to the illustrated configuration and the presence of the upper 13 and lower 14 cups (these cups 13, 14 are provided with a peripheral edge that acts as protection during placement of the implant 1. This profile prevents elimination of the autologous grip during progression of the implant 1 towards its final osseous site), the stem cells are kept in place in the housing during the progression of the implant 1 into the hole 16. These cells are thus neither degraded nor lost during the implantation phase.

The combinations of cups 13 and 14 that form the reservoirs for the stem cells or autologous pre-osseous cells are advantageously placed to come directly into contact with the spongiosa that is the most vascularized and cellularly rich part of the osseous tissue comprising the receiving bed of the implant 1.

The cups 13, 14 bearing the pre-osseous stem cells can, moreover, comprise a nanometric pattern 15 as indicated above. The pairing of the stratifying osteotome comprising the drilling tool 21, the layers of the implant 1, and especially its conical parts, the conformation of the cups 13, 14 allowing primary adhesion of the pre-osseous cells placed directly in contact with the active part of the osseous receiving part allows accelerated osseous regrowth regardless of the implanted osseous zone. The cups 13, 14 are advantageously produced at the level of the central anchoring zone 3 of the implant 1.

The shape of the illustrated reservoir that is implemented with a groove in at least certain threads and that has two cups 13, 14 could, however, be different without exceeding the scope of the invention. In particular, other machining profiles of the thread base are possible.

It should be noted that the drilling tool 21 that is shown here and that has been implemented in a manner homologous to the implant 1 is preferably for one-time use, so as to produce a combination of the implant 1 and the tool 21 that is perfectly suitable and with very limited tolerances. It should be noted that currently the existing implant systems have differences in threading and in the state of the surface and shape that result in the drilling tools being used successively, and a large number of them are poorly adapted.

One possibility of use with an operating protocol is described below.

Twenty-one days before placing the implant, mini-traumatism at the level of the jaws using a trans-osseous trocar is done.

The stem cells are loaded onto the implant 1 as follows:
The patient's blood is taken. This blood is then extemporaneously centrifuged in the surgical unit and the three phases are separated, i.e., serum, fibrin clots and red cells.
The implant 1 is immersed directly in the serum. Due to its structure comprising primary 8 and secondary 9 threadings and the pattern 15 as well as the cups 13, 14, its wettability is considerably enhanced. The proteins that are contained in the serum will be adsorbed on the preferably pure titanium surface of the implant 1, thus also comprising an interface of molecules favorable to the future adhesion of the pre-osseous cells and the osseous cells removed extemporaneously at the level of the periosteum of the patient.
The stem cells and/or pre-osseous cells are removed at the level of the gap made previously (twenty-one days earlier) as well as several microfragments of cortical bone collected in the primary trauma zone using a microloader (curette trocar) for stem cells and placed in the serum-filled reservoirs located on the sides of the implant 1 (cups 13, 14).
The implant is used both as a dental implant and transplant carrier. It is then introduced into the osseous bed that is specifically profiled by the drilling tool 21 shown in the form of a hole 16 that has several cylinders of increasing diameter. The conical parts of the implant 1 allow the successive cylindrical layers of the hole 16 to be crossed, with a friction surface that is present but reduced. The arrangement accomplished in this way prevents evacuation of the cellular transplants in the course of placement of the implant without thereby endangering its primary locking in the bone.
The various stages implemented at the level of the hole 16 by the drilling tool 21 and formed corresponding to the implant 1 allow axial locking of the structure of the implant 1. Each zone of the implant behaves like a non-return system allowing absolute primary stabilization of the implant 1 in the osseous receiving bed. This optimum primary immobility is long-lasting and essential for proliferation of the osseous cells and for the maturation of the osseous tissue around the implant 1, thus avoiding any risk of rejection.

It should be noted that the bipolar grasping mode implemented either by the lower surface 7 or by the connection means 6 allows very practical manipulation in the impregnation phase of the implant 1 in the serum.

In conclusion, the invention integrates the parameters of the biological and genetic nature of the patient at the same time as the simplicity of placement using a single drill that stratifies the osseous receiving bed to allow automatic placement that promotes primary locking of the implant 1. The immediate result of placing the stem cells and/or pre-osseous cells of the bearer implant 1 in contact with the microcirculation of the receiving bed will be the development of osseous tissue on the implant 1, for this reason eliminating any risk of rejection. This is particularly effective when scanner examination reveals a receiving osseous site of medium to mediocre quality.

The reservoirs bearing the stem cells and/or autologous pre-osseous cells make it possible to “boost” the osseous response without passing through a prior, in vitro cellular culture or using a product of animal origin. Actually, using the implant of the invention, genuine transplantation in vivo of the patient's own stem cells themselves and/or pre-osseous cells is done at the same time as the placement of the implant 1.

There is no need to study antigenicity, carcinogenicity, viruses, prions, etc. The patient runs no risk relating to his own cells extracted in situ and extemporaneously transplanted at the same time as the installation of the implant 1.

### REFERENCES

1. Implant

2. Base zone

3. Central anchoring zone

4. Terminal anchoring zone

5. Stop zone

6. Means of prosthetic connection

7. Lower surface

8. Primary threading

9. Secondary threading

10a, 10b, 10c, 10d. Longitudinal tapping grooves

11. Stop surface in translation

12. Side of the thread

13. Upper cup

14. Lower cup

15. Nanometric pattern

16. Hole

17. Apical zone

21. Drilling tool

22. Apical pilot drilling stage

23. Central widening stage

24. Terminal drilling stage

25. Stop stage

26. Lateral surface

27. Coupling body

28. Dense bone

29. Spongy bone

30. Nerve

31. Centering stage

1. Dental implantology device comprising a tool for drilling (21) the jawbone and an implant (1) that is able to anchor a prosthetic device, characterized in that:
a—The drilling tool (21) has five stages with the following in succession:
a centering stage (31) at the level of the distal end,
an apical pilot drilling stage (22),
a stage of central widening (23) of a diameter that is larger than that of the pilot drilling stage (22),
a terminal drilling stage (24) with a diameter that is larger than that of the preceding stages,
a crestal stop stage (25) at the level of the proximal end of the drilling tool (21);
b—The implant (1) is shaped homologously to the drilling tool (21) and comprises five zones over its height, with the following in succession:
an apical rounded zone (17) with a height that is essentially less than or equal to that of the centering stage (31),
a truncated conical base zone (2) with a height that is essentially equivalent to that of the apical pilot drilling stage (22) of the drilling tool (21),
a central cylindrical anchoring zone (3) with a height that is essentially equivalent to that of the central widening stage (23) of the drilling tool (21),
a terminal, truncated conical anchoring zone (4) with a height that is essentially equivalent to that of the terminal drilling stage (24) of the drilling tool (21),
a stop zone (5) with a height that is essentially equivalent to that of the crestal stop stage (25) of the drilling tool (21).

2. Device according to claim 1, wherein the terminal anchoring zone (4) of the implant has a height of between 20% and 35% of the total height of the implant (1).

3. Device according to claim 1, wherein the terminal anchoring zone (4) of the implant (1) has a height of between 1.7 and 3.5 mm.

4. Device according to claim 1, wherein the stop stage (5) of the drilling tool (21) is a recess whose lateral surface has a section profile.

5. Device according to claim 1, wherein the implant (1) comprises four lengthwise tapping grooves (10a, 10b, 10c, 10d) starting from the apical zone (17) to the terminal anchoring zone (4).

6. Device according to claim 1, wherein the central anchoring zone (3) and the base zone (2) of the implant (1) comprise a primary threading (8), on the surface of which a secondary threading (9) of a smaller dimension is formed.

7. Device according to claim 6, wherein the primary threading (8) has a pitch of 0.9 mm, and the secondary threading (9) has a pitch of between 0.25 mm and 0.4 mm.

8. Device according to claim 6, wherein the terminal anchoring zone (4) of the implant (1) comprises threading whose pitch is between 0.25 mm and 0.4 mm.

9. Device according to claim 6, wherein the threaded peripheral surface of the implant (1) has an additional nanometric pattern.

10. Device according to claim 8, wherein the sides of the primary threading comprise receiving cups (13, 14) of the stem cells.

11. Device according to claim 8, wherein the primary threading (8) is symmetrically trapezoidal.

12. Device according to claim 8, wherein the primary threading (8) is asymmetrically trapezoidal.

13. Device according to claim 8, wherein the primary threading (8) has a rectangular profile.

14. Device according to claim 2, wherein the terminal anchoring zone (4) of the implant (1) has a height of between 1.7 and 3.5 mm.

15. Device according to claim 2, wherein the implant (1) comprises four lengthwise tapping grooves (10a, 10b, 10c, 10d) starting from the apical zone (17) to the terminal anchoring zone (4).

16. Device according to claim 2, wherein the central anchoring zone (3) and the base zone (2) of the implant (1) comprise a primary threading (8), on the surface of which a secondary threading (9) of a smaller dimension is formed.

17. Device according to claim 7, wherein the terminal anchoring zone (4) of the implant (1) comprises threading whose pitch is between 0.25 mm and 0.4 mm.

18. Device according to claim 9, wherein the sides of the primary threading comprise receiving cups (13, 14) of the stem cells.

19. Device according to claim 9, wherein the primary threading (8) is symmetrically trapezoidal.

20. Device according to claim 9, wherein the primary threading (8) is asymmetrically trapezoidal.
